(19) United States
(12) Patent Application Publication
(10) Pub. No.: US 2025/0061339 A1
(43) Pub. Date: Feb. 20, 2025

(54) MODEL TRAINING OF ACTOR MODEL AND CRITIC MODEL

(71) Applicant: Lemon Inc., Grand Cayman (KY)

(72) Inventors: Andrew Estornell, Los Angeles, CA (US); Jean-Francois Ton, London (GB); Yuanshun Yao, Los Angeles, CA (US); Yang Liu, Los Angeles, CA (US)

(21) Appl. No.: 18/936,628

(22) Filed: Nov. 4, 2024

(51) Int. Cl. G06N 3/092; G06F 40/40

(52) U.S. Cl. CPC G06N 3/092; G06F 40/40

(57) ABSTRACT

Embodiments of the present disclosure provide a solution for model training. A method comprises: performing training of a critic model and training of an actor model according to an alternating scheme. The actor model is configured to generate a response for an input question based on a feedback generated by the critic model, and the critic model is configured to generate a feedback to a response generated by the actor mode.

### FIELD

The disclosed example embodiments relate generally to machine learning and, more particularly, to a method, apparatus, device and computer readable storage medium for training an actor model and a critic model.

### BACKGROUND

Machine learning models (such as large language models (LLMs)) have demonstrated a remarkable ability to serve as general-purpose tools for various language-based tasks. Recent works have demonstrated that the efficacy of such LLMs can be improved through iterative dialog between multiple models, frequently referred to as multi-agent debate (MAD). While debate shows promise as a means of improving model efficacy, most works treat debate as an emergent behavior, rather than a learned behavior, and the efficacy of the LLMs still needs further improvement.

### SUMMARY

In a first aspect of the present disclosure, a method for model training is provided. The method includes performing training of a critic model and training of an actor model according to an alternating scheme. The actor model is configured to generate a response for an input question based on a feedback generated by the critic model, and the critic model is configured to generate a feedback to a response generated by the actor mode. The training of the critic model includes training the critic model based on a first difference between a first target predicted response generated by the actor model for a first sample question and a first ground-truth response of the first sample question. The training of the actor model includes training the actor model based on a second difference between a second target predicted response generated by the actor model for a second sample question and a second ground-truth response of the second sample question.

In a second aspect of the present disclosure, an apparatus for model training is provided. The apparatus includes a training module configured to perform training of a critic model and training of an actor model according to an alternating scheme. The actor model is configured to generate a response for an input question based on a feedback generated by the critic model, and the critic model is configured to generate a feedback to a response generated by the actor mode. The training module includes a first training submodule configured to train the critic model based on a first difference between a first target predicted response generated by the actor model for a first sample question and a first ground-truth response of the first sample question. The training module includes a second training submodule configured to train the actor model based on a second difference between a second target predicted response generated by the actor model for a second sample question and a second ground-truth response of the second sample question.

In a third aspect of the present disclosure, an electronic device is provided. The device includes at least one processing unit; and at least one memory coupled to the at least one processing unit and storing instructions executable by the at least one processing unit. The instructions, upon execution by the at least one processing unit, cause the device to perform the method of the first aspect.

In a fourth aspect of the present disclosure, a computer-readable storage medium is provided. The medium stores a computer program which, when executed by a processor, causes the method of the first aspect to be implemented.

In a fifth aspect of the present disclosure, a computer program product is provided. The computer program product includes a computer program which, when executed by a processor, causes the method of the first aspect to be implemented.

It would be appreciated that the content described in the Summary section of the present invention is neither intended to identify key or essential features of the embodiments of the present disclosure, nor is it intended to limit the scope of the present disclosure. Other features of the present disclosure will be readily envisaged through the following description.

### BRIEF DESCRIPTION OF THE DRAWINGS

The above and other features, advantages and aspects of the embodiments of the present disclosure will become more apparent in combination with the accompanying drawings and with reference to the following detailed description. In the drawings, the same or similar reference symbols refer to the same or similar elements, where:

FIG. 1 illustrates a schematic diagram of an example environment in which embodiments of the present disclosure may be implemented;

FIG. 2 illustrates an example diagram for architecture of model training in accordance with some embodiments of the present disclosure;

FIG. 3 illustrates an example diagram of a training system in accordance with some embodiments of the present disclosure;

FIG. 4 illustrates an example algorithm in accordance with some embodiments of the present disclosure;

FIG. 5 illustrates a flow chart of a process for model training in accordance with some embodiments of the present disclosure;

FIG. 6 illustrates a block diagram of an apparatus for model training according to some embodiments of the present disclosure; and

FIG. 7 illustrates a block diagram of an electronic device in which one or more embodiments of the present disclosure can be implemented.

### DETAILED DESCRIPTION

The embodiments of the present disclosure will be described in more detail below with reference to the accompanying drawings. Although some embodiments of the present disclosure are shown in the drawings, it would be appreciated that the present disclosure may be implemented in various forms and should not be interpreted as limited to the embodiments described herein. On the contrary, these embodiments are provided for a more thorough and complete understanding of the present disclosure. It would be appreciated that the drawings and embodiments of the present disclosure are only for the purpose of illustration and are not intended to limit the scope of protection of the present disclosure.

In the description of the embodiments of the present disclosure, the term “including” and similar terms would be appreciated as open inclusion, that is, “including but not limited to”. The term “based on” would be appreciated as “at least partially based on”. The term “one embodiment” or “the embodiment” would be appreciated as “at least one embodiment”. The term “some embodiments” would be appreciated as “at least some embodiments”. Other explicit and implicit definitions may also be included below. As used herein, the term “model” can represent the matching degree between various data. For example, the above matching degree can be obtained based on various technical solutions currently available and/or to be developed in the future.

It will be appreciated that the data involved in this technical proposal (including but not limited to the data itself, data acquisition or use) shall comply with the requirements of corresponding laws, regulations and relevant provisions.

It will be appreciated that before using the technical solution disclosed in each embodiment of the present disclosure, users should be informed of the type, the scope of use, the use scenario, etc. of the personal information involved in the present disclosure in an appropriate manner in accordance with relevant laws and regulations, and the user's authorization should be obtained.

For example, in response to receiving an active request from a user, a prompt message is sent to the user to explicitly prompt the user that the operation requested operation by the user will need to obtain and use the user's personal information. Thus, users may select whether to provide personal information to the software or the hardware such as an electronic device, an application, a server or a storage medium that perform the operation of the technical solution of the present disclosure according to the prompt information.

As an optional but non-restrictive implementation, in response to receiving the user's active request, the method of sending prompt information to the user may be, for example, a pop-up window in which prompt information may be presented in text. In addition, pop-up windows may also contain selection controls for users to choose “agree” or “disagree” to provide personal information to electronic devices.

It will be appreciated that the above notification and acquisition of user authorization process are only schematic and do not limit the implementations of the present disclosure. Other methods that meet relevant laws and regulations may also be applied to the implementation of the present disclosure.

As used herein, the term “model” can learn a correlation between respective inputs and outputs from training data, so that a corresponding output can be generated for a given input after training is completed. The generation of the model can be based on machine learning techniques. Deep learning is a machine learning algorithm that processes inputs and provides corresponding outputs by using multiple layers of processing units. A neural networks model is an example of a deep learning-based model. As used herein, “model” may also be referred to as “machine learning model”, “learning model”, “machine learning network”, or “learning network”, and these terms are used interchangeably herein.

“Neural networks” are a type of machine learning network based on deep learning. Neural networks are capable of processing inputs and providing corresponding outputs, typically including input and output layers and one or more hidden layers between the input and output layers. Neural networks used in deep learning applications typically include many hidden layers, thereby increasing the depth of the network. The layers of neural networks are sequentially connected so that the output of the previous layer is provided as input to the latter layer, where the input layer receives the input of the neural network and the output of the output layer serves as the final output of the neural network. Each layer of a neural network includes one or more nodes (also known as processing nodes or neurons), each of which processes input from the previous layer.

Usually, machine learning can roughly include three stages, namely training stage, test stage, and application stage (also known as inference stage). During the training stage, a given model can be trained using a large scale of training data, iteratively updating parameter values until the model can obtain consistent inference from the training data that meets the expected objective. Through the training, the model can be considered to learn the correlation between input and output (also known as input-to-output mapping) from the training data. The parameter values of the trained model are determined. In the test stage, test inputs are applied to the trained model to test whether the model can provide correct outputs, thereby determining the performance of the model. In the application stage, the model can be used to process actual inputs and determine corresponding outputs based on the parameter values obtained from training.”

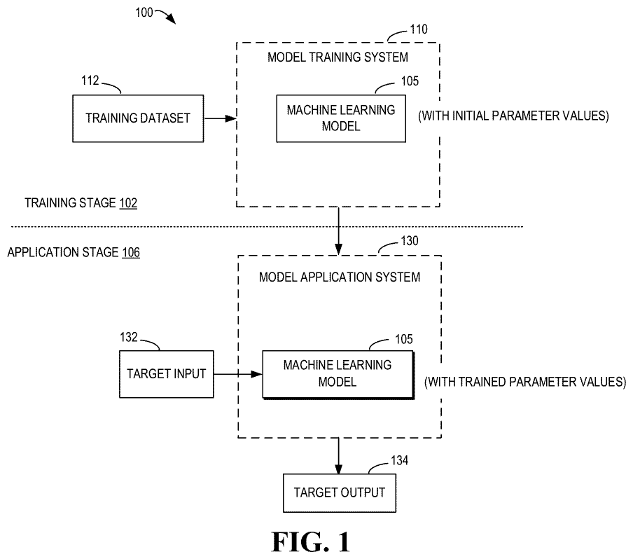

FIG. 1 illustrates a schematic diagram of an example environment 100 in which embodiments of the present disclosure can be implemented. In the environment 100 of FIG. 1, three different stages of a model are shown, including a training stage 102, a fine-tuning stage (not shown), and an application stage 106. After the training or fine-tuning stage is completed, there may also be a validation stage, which is not shown in FIG. 1.

In the training stage 102, a model training system 110 is configured to perform training of a machine learning model 105 using a training dataset 112. At the beginning of training, the model can have initial parameter values. The training process involves updating the parameter values of the machine learning model 105 to expected values based on the training data. In some embodiments, the training stage 102 may involve a pretraining stage and a fine-tuning stage.

In the application stage 106, the obtained machine learning model 105 has trained parameter values that may be provided to a model application system 130 for use. In the application stage 106, the machine learning model 105 can be used to process a target input 132 in actual scenarios and provide a corresponding target output 134. In some embodiments where the machine learning model 105 is capable of question answering, for example, the machine learning model 105 is a generative model for content generation, the target input 132 may be a prompt input (which can be considered as a question), and the target output 134 may be a response or answer for the prompt input. In some examples where the machine learning model 105 is constructed based on a language model, the prompt input may include a text sequence and the response or answer may also include a text sequence for the answer.

In FIG. 1, the model training system 110 and the model application system 130 may include any computing system with computing capability, such as various computing devices/systems, terminal devices, servers, etc. Terminal devices may involve any type of mobile terminals, fixed terminals, or portable terminals, including mobile phones, desktop computers, laptops, netbooks, tablets, media computers, multimedia tablets, or any combination of the aforementioned, including accessories and peripherals of these devices or any combination thereof. Servers include but are not limited to mainframe, edge computing nodes, computing devices in cloud environment, etc.

It should be understood that the components and arrangements in the environment 100 shown in FIG. 1 are merely examples, and a computing system suitable for implementing the example embodiments described in the present disclosure may include one or more different components, other components, and/or different arrangements. For example, although shown as separate, the model training system 110 and the model application system 130 may be integrated into the same system or device. The implementation of the present disclosure is not restricted in this regard.

It should be understood that the structure and function of each element in the environment 100 is described for illustrative purposes only and does not imply any limitations on the scope of the present disclosure.

Recently, large language models (LLMs) have rapidly become a cornerstone in various applications. Their ability to handle diverse tasks, from translation to answering complex questions, has attracted the attention of both industry as well as academia. However, despite these advancements, LLMs still exhibit notable weaknesses, particularly when it comes to answering factual questions and reasoning.

To address these limitations, several techniques have been proposed, such as Chain-of-Thought (CoT) prompting, self-reflection, and multiagent debate (MAD). These approaches aim to improve the reasoning abilities of LLMs by guiding them toward more accurate answers through structured thinking or discourse. However, the majority of these techniques do not involve training the model specifically for these tasks but instead rely on zero-shot or few-shot capabilities.

In particular, multi-agent debate approaches make use of off-the-shelf general-purpose LLMs, which are not trained to collaborate. Such approaches rely on collaboration as an emergent, rather than a learned, behavior. While, in some cases, these emergent behaviors are sufficient, the question remains: Can these methods be improved by imbuing models directly with collaborative abilities?

According to a solution, debate among models is used as a mechanism to attain higher-quality fine-tuning data. This solution focuses on using debate to generate better training data for a single model that gives single responses, rather than optimizing the LLMs themselves for collaborative problem-solving over multiple rounds of conversation.

The approaches to multi-agent debate are broadly cast into two main categories: those that modify model prompts and responses during the debate, and those that modify the structure of the debate process. Both categories use off-the-shelf language models (which have not been trained to collaborate) and work by modifying either the inputs or outputs of these models.

According to a further solution, a method to use debate data to fine-tune models is provided, which trains models for adversarial debate. The debate is used to generate higher-quality fine-tuning data and is not used at inference time. And, models are trained to be effective arguers rather than collaborators, i.e., models are trained to give conceiving arguments such that they can win a debate against other LLMs.

In view of the above, embodiments of the present disclosure provide a solution for model training based on multi-model debate. A two-model team are trained according to an alternating scheme. The two-model team includes an actor model and a critic model. The actor model is configured to generate a response for an input question based on a feedback generated by the critic model. The critic model is configured to generate a feedback to a response generated by the actor mode. The training of the critic model includes training the critic model based on a first difference between a first target predicted response generated by the actor model for a first sample question and a first ground-truth response of the first sample question. The training of the actor model includes training the actor model based on a second difference between a second target predicted response generated by the actor model for a second sample question and a second ground-truth response of the second sample question. The trained actor model and critic model may then be provided as a model for question and answering.

The solution of the present disclosure provides a framework Actor-Critic Debate (ACC-Debate) which jointly trains the two-model team to collaboratively solve problems through iterative conversation, which may improve the model for question and answering. In some embodiments of the present disclosure, it may further provide an off-policy learning scheme called “guided-debate” to generate high-quality multi-turn training data to enhance the actor's and critic's performance on challenging tasks.

Example embodiments of the present disclosure will be described in detail below with reference to the accompanying drawings.

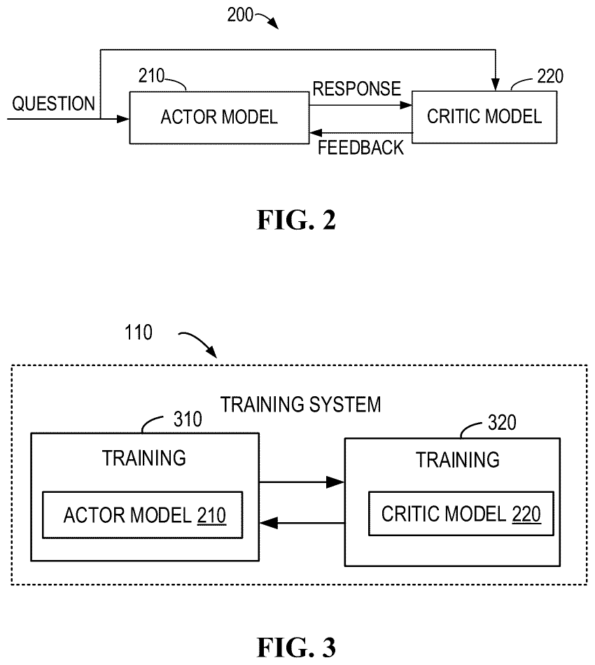

FIG. 2 illustrates an example diagram for architecture 200 of model training in accordance with some embodiments of the present disclosure. The architecture 200 includes an actor model 210 and a critic model 220. The actor model 210 acts as an actor agent responsible for providing an answer to a given question or task. The critic model 220 acts as a critic agent responsible for providing feedback and assistance to the actor model 210. The feedback of the critic model 220 may evaluating if the answer of the actor model 210 is accurate or not. In the following, the actor model and the actor agent are used interchangeably, and the critic model and the critic agent are used interchangeably.

In some embodiments, the actor model 210 and the critic model 220 may be constructed based on a language model, to process an input in natural language and provide the output in natural language. In some embodiments, in addition to the question input to the actor model 210 or the answer to be evaluated by the critic model 220, corresponding prompt information may also be provided to the actor model 210 and the critic model 220, to guide the actor model or the critic model to process their input and provide the corresponding output.

As illustrated in FIG. 2, for a given question or task, the actor model 210 and the critic model 220 may engage in an iterative interaction to output or provide a final response or answer. As an example, let (x, y)˜D be a question-answer pair sourced from a distribution of questions and answers, D. For a given question x, the actor model 210 and the critic model 220 may engage in an iterative interaction over T rounds, to correctly provide the answer y. Let θₐ and θ_{c} be the parameters of actor model 210 and the critic model 220, respectively. The iterative discussion between these two models may include the followings steps.

At round t=0, a question x is provided to the actor model 210. The actor model 210 may generate an initial response zₐ⁽⁰⁾.

Still at round t=0, the question x and the initial response zₐ⁽⁰⁾ are provided to the critic model 220. The critic model 220 may process the question x and the initial response zₐ⁽⁰⁾, and then generate a feedback z_{c}⁽⁰⁾.

For each round t>0, the question x, a previous response zₐ^{(t-1)} generated by the actor, model 210 in a previous round, and a feedback z_{c}^{(t-1)} generated by the critic model 220 in the previous round are provided to the actor model 210. The actor model 210 may process the question x, the previous response zₐ^{(t-1)} and the feedback z_{c}^{(t-1)}, and then provide an updated response zₐ^{(t)}.

The updated response zₐ^{(t)} may then be provided to the critic model 220, and the critic model may provide a feedback z_{c}^{(t)} based on the updated response zₐ^{(t)}.

The interaction between the actor model 210 and the critic model 220 may continue until T rounds. At round T, the actor model 210 provides a final response zₐ^{(t)} to the question x. T is an integer, t is an integer, and t≤T.

FIG. 3 illustrates an example diagram of a training system 110 in accordance with some embodiments of the present disclosure. As illustrated in FIG. 3, the training system 110 includes a training stage 310 for training the actor model 210 and a training stage 320 for training the critic model 220.

In embodiments of the present disclosure, the critic model 220 and the actor model 210 may be trained according to an alternating scheme. The training stage 320 includes training the critic model 220 based on a first difference between a first target predicted response generated by the actor model 220 for a first sample question and a first ground-truth response of the first sample question. The training stage 310 includes training the actor model 210 based on a second difference between a second target predicted response generated by the actor model 210 for a second sample question and a second ground-truth response of the second sample question. That is, the losses (or differences) used in training the actor model 210 and the critic model 220 are both determined based on the predicted response of the actor model 210 and the ground-truth response, although the critic model 220 is only used to generate a feedback for the predicted response of the actor model 210.

In some example embodiments, in the training stage 320 for training the critic model 220, for a given sample question, the actor model 210 and the critic model 220 may engage in an iterative interaction over T rounds. At each round t (where t=0, 1, 2, . . . . T), the critic model 220 may generate a predicted feedback, and the actor model 210 may generate a predicted response. The sample question may be labeled with a ground-truth response. The pair of sample question and the ground-truth response may be sampled from a training dataset including multiple pairs of sample question and ground-truth responses that are used to train the actor model 210 and the critic model 220.

For example, at round t=0, a first sample question is provided to the actor model 210 to generate a predicted Repones 0. Then the first sample question and the predicted Repones 0 are given to the critic model 220 to generate a predicted Feedback 0. At next round, the first sample question, the predicted Repones 0 and the predicted Feedback 0 are given to the actor model 210 to generate a predicted Response 1. Then the first sample question and the predicted Response 1 are given to the critic model 220 to generate a predicted Feedback 1. At a further next round, the first sample question, the predicted Response 1 and the predicted Feedback 1 are given to the actor model 210 to generate a predicted Response 2. Then the first sample question and the predicted Response 2 are given to the actor model 220 to generate a predicted Feedback 2.

The interaction may continue until the last round (for example, the target round T), the actor model 210 generates a final predicted response T (i.e., the first target predicted response). The critic model 220 is then trained based on the first difference between the first target predicted response and the first ground-truth response of the first sample question. In some embodiments, the training stage 320 may be performed based on multiple pairs of sample questions and ground-truth responses, to allow the model parameters of the critic model 220 to be updated in such a way that the question-answering accuracy may be improved.

In some example embodiments, in the training stage 310 for training the critic model 220, for a given second sample question, the actor model 210 and the critic model 220 may engage in a further iterative interaction over T rounds. At each round t, the critic model 220 may generate a predicted feedback, and the actor model 210 may generate a predicted response.

For example, at round t=0, the second sample question is provided to the actor model 210 to generate a predicted Repones 0′. Then the second sample question and the predicted Repones 0′ are given to the critic model 220 to generate a predicted Feedback 0′. At next round, the second sample question, the predicted Repones 0′ and the predicted Feedback 0′ are given to the actor model 210 to generate a predicted Response 1′. Then the second sample question and the predicted Response 1′ are given to the critic model 220 to generate a predicted Feedback 1′. At further next round, the second sample question, the predicted Response 1′ and the predicted Feedback 1′ are given to the actor model 210 to generate a predicted Response 2′. Then the second sample question and the predicted Response 2′ are given to the actor model 220 to generate a predicted Feedback 2′.

The interaction may continue until the last round (for example, the target round T), the actor model 210 generates a final predicted response T′ (i.e., the second target predicted response). The actor model 210 is then trained based on the second difference between the second target predicted response and the second ground-truth response of the second sample question. In some embodiments, the training stage 310 may be performed based on multiple pairs of sample questions and ground-truth responses, to allow the model parameters of the actor model 210 to be updated in such a way that the question-answering accuracy may be improved.

It would be appreciated that in the alternating scheme of training, either of the actor model 210 or the critic model 220 may be trained first. It should also be noted that the first sample question and the second sample question are examples of the above question x. The Feedback 0, the Feedback 0′, the Feedback 1, the Feedback 1′, etc. are examples of the above feedback z_{c}⁽⁰⁾, . . . , z_{c}^{(t)}, . . . z_{c}^{(T)}. The Response 0, the Response 0′, the Response 1, the Response 1′, etc. are examples of the above response zₐ⁽⁰⁾, . . . , zₐ^{(t)}, . . . zₐ^{(T)}. In the following, for purpose of discussion, the feedback z_{c}⁽⁰⁾, . . . z_{c}^{(T)}, . . . z_{c}^{(T)} may be used to indicate either feedback (e.g., the first predicted feedback, the second predicted feedback) generated by the critic model 220 for the first sample question or for the second sample question, and the predicted response zₐ⁽⁰⁾, . . . , zₐ^{(t)}, . . . zₐ^{(T)} may be used to indicate either response (e.g., the first predicted response, the second predicted response, etc., or the first target predicted response, the second target predicted response, etc.) generated by the actor model 210 for the first sample question or for the second sample question. The present disclosure is not limited it in this regard.

In some embodiments, for the predicted response zₐ^{(T)}, the accuracy may be measured via its correctness as compared to the ground-truth response y, i.e., [symbol] [ζ(zₐ^{(T)})=y], where ζ is a function that extracts answers from text-based responses. For example, if zₐ^{(T)}=“The sky is blue”, then ζ(zₐ^{(T)})=“blue”.

In some example embodiments, an optimization objective for the actor model 210 and the critic model 220 may be defined as follows:

$${θ}_{a}^{*} , {θ}_{c}^{*} = arg {max}_{{θ}_{a}} {max}_{{θ}_{c}} {𝔼}_{( x , y ) ∼ D} [ ζ ( {\underbrace{{f}_{{θ}_{a}} ( x , {z}_{a}^{( T - 1 )} , {z}_{c}^{( T - 1 )} )}}_{actor ' s final resonse {z}_{a}^{( T )}} ) = y ] \qquad ( 1 )$$

The Eq. (1) may aim to simultaneously optimize the actor model's parameters θₐ and critic model's parameters θ_{c}, ensuring that the actor model 210's final response at round T matches the correct answer y. Here, the term

$$arg {max}_{{θ}_{a}} {max}_{{θ}_{b}}$$

captures the solution for both parameters θₐ and θ_{c} in the corresponding bi-level max-max optimization. θ_{c} is in z_{c}^{(T-1)}=f_{θ}_{_{c}}(x, zₐ^{(T-1)}).

In other words, the accuracy of the final response of the actor model 210 at round T, i.e., zₐ^{(T)}=f_{θ}_{ₐ}(x,zₐ^{(T-1)}, z_{c}^{(T-1)}) is optimized, where accuracy is measured as [symbol] [ζ(zₐ^{(T)}=y].

As described above, each response zₐ^{(t)} depends not only on the actor model's previous response zₐ^{(t-1)}, but also on the critic model's previous feedback z_{c}^{(t-1)}. This interaction closely resembles a cooperative dynamic Stackelberg game, where two players engage in hierarchical decision-making over time. In embodiments of the present disclosure, the critic model 220 is trained first, and then the actor model 210 is trained to best respond to the critic model 220's feedback. Then, the critic model 220 may be updated to adapt to the newly trained actor model, and so on. For example, this process works by first updating θₐ of the critic model 220 by solving:

$${θ}_{c}^{*} = arg {max}_{{θ}_{c}} {𝔼}_{( x , y ) ∼ D} [ ζ ( {f}_{{θ}_{a}} ( x , {z}_{a}^{( T - 1 )} , {\underbrace{{f}_{{θ}_{c}} ( x , {z}_{a}^{( T - 1 )} )}}_{critic ' s resonse {z}_{c}^{( T - 1 )}} ) ) = y ] \qquad ( 2 )$$

Then, fixing θ_{c}* of the actor model 210 from the above Eq. (2) by solving:

$${θ}_{a}^{*} = arg {max}_{{θ}_{a}} {𝔼}_{( x , y ) ∼ D} [ ζ ( {f}_{{θ}_{a}} ( x , {z}_{a}^{( T - 1 )} , {f}_{{θ}_{c}^{*}} ( x , {z}_{a}^{( T - 1 )} ) ) ) = y ] \qquad ( 3 )$$

This process repeats until a predetermined stopping criterion is reached. In some example embodiments, the predetermined stopping criterion may be the number of the iterations reaches a first predetermined threshold. Alternatively, the predetermined stopping criteria may also be that the loss function is less than a second predetermined threshold. Embodiments of the present disclosure do not limit it.

With the iterating scheme, although the actor model and the critic model may be optimized separately, the objectives of each model may not be optimized directly due to the recursive nature of model responses. For example, the response at round T depends on those given by both the actor model and the critic model at round T−1, and the response at round T−1 depends on the response given at round T−2, and so on. To deal with this temporal dependency, the present disclosure further provides a partial trajectory reward scheme.

In the scheme, for any t≤T, the “goodness” or “correctness” of a given response z^{(t)} (from either the actor model or the critic model) may be determined.

To assess the correctness of a response z^{(t)}, the present disclosure considers define this as:

$$r ( {z}^{( t )} , x , y ) = 𝔼 [ ζ ( {z}_{a}^{( T )} ) = y \vert x , {z}^{( t )} ]$$

The partial reward captures the expectation of arriving at the correct answer y through debate starting at each round t with response z^{(t)}. r(z^{(t)},x,y) may be estimated by learning the reward model r or by using heuristics such as one-step roll-out, i.e., Monte Carlo estimation. The reward may be increase as the correctness of the response z^{(t)} increases.

The objective will then be to optimize the parameter θₐ of the actor model 210 and the parameter θ_{c} of the critic model 220, such that response (namely, z^{(t)}) generated by these models at each round t maximizes r(z^{(t)},x,y).

In some embodiments, the actor model 210 and the critic model 220 may be optimized, such that at each round t (or timestep t), the generated response z^{(t)} has a high probability of leading the debate to converge to the correct answer at round T.

To optimize the objective in Eq. (1), preference optimization may be utilized, and pairwise preference data for both the actor model 210 and the critic model 220 needs to be obtained. The process for generating this preference data before delving into the optimization procedure will be described below.

In some example embodiments, a guided-debate mechanism may be applied to improve the model training performance. During the training, guidance information may be provided to the actor model 210 to generate the corresponding guided response. At each round, the actor model 210 may generate a response and the critic model 220 may generate a feedback with respect to the first sample question. In the following, the round t will be taken as an example for describing the iteration interaction between the critic model 220 and the actor model 210.

In the round t (also referred to as a first round), the actor model 210 may generate a predicted Response t (e.g., a second predicted response) based on the first sample question, and the predicted Response t−1 (e.g., a first predicted response) generated by the actor model 210 at the round t−1, and a Feedback t (e.g., a first feedback) to the predicted Response t−1 generated by the critic model 220 in the round t−1.

In some example embodiments, first guidance information for guiding the actor model 210 to generate the response towards the first ground-truth response of the first sample question may be provided to the actor model 210.

Still in the round t, the actor model 210 may generate a guided Response ť (e.g., a second guided response) based on the first sample question, a guided Response ť−1 (e.g., a first guided response generated by the actor model 210 at round t−1), a guided Feedback ť−1 (e.g., a first guided feedback) to the guided Response ť−1 generated by the critic model 220 in the first round t−1 and the first guidance information.

In some example embodiments, second guidance information for guiding the actor model 210 to generate the response to be distinguished from the first ground-truth response of the first sample question may be provided to the actor model 210.

Still in the round t, the actor model 210 may generate a guided Response t̅ (e.g., a fourth guided response) based on the first sample question, a guided Response t̅−1 (e.g., a third guided response generated by the actor model 210 at round t−1), a guided Feedback t̅−1 (e.g., a second guided feedback) to the guided Response t̅−1 generated by the critic model 220 in the first round t−1, and the second guidance information.

The critic model 220 may then be trained based on the predicted Response t, the guided Response ť, the guided Response t̅, and the first ground-truth response of the first sample question.

In some example embodiments, the reward of each of the predicted Response t, the guided Response ť, the guided Response t̅ may be determined. Then, a first reward difference between the reward of the predicted Response t and the reward of guided Response ť may be determined, and a second reward difference between the reward of the predicted Response t and the reward of guided Response t̅ may be determined. Then, the critic model 220 may be trained based on the first reward difference and the second reward difference.

In some example embodiments, to obtain the preference data (e.g. the positive sample and the negative sample), the performance of the predicted Response t generated without guidance information may be compared with that of the guided Response ť generated with positive guidance information (i.e., the first guidance information), and the performance of the predicted Response t may also be compared with that of the guided Response t̅ generated with negative guidance information (i.e., the second guidance information).

In some example embodiments, the first reward difference may be compared with a first threshold. In accordance with a determination that the first reward difference exceeds the first threshold, the guided Response ť and the predicted Response t may be determined to be a first pair of positive and negative samples. Similarly, the second reward difference may also be compared with the first threshold. In accordance with a determination that the second reward difference exceeds the first threshold, the predicted Response t and the guided Response t̅ may be determined to be a second pair of positive and negative samples.

In some example embodiments, with the two pairs of the samples, a direct preference optimization (DPO) loss may be determined. In an embodiment, a first DPO loss may be determined based on at least one of the first pair of positive and negative samples, and the second pair of positive and negative samples, and the critic model 220 may be trained based on the first DPO loss.

In some example embodiments, the actor model 210 may be trained similarly. For example, in the round t, the actor model 210 may generate a predicted Response t′ (e.g., a fourth predicted response) based on the second sample question, and the predicted Response t′−1 (e.g., a third predicted response) generated by the actor model 210 at the round t−1, a Feedback t′ (e.g., a second feedback) to the predicted Response t′−1 generated by the critic model 220 in the round t−1.

Still in the round t, the actor model 210 may generate a guided Response ť′ (e.g., a sixth guided response) based on second sample question, a guided Response [symbol] −1 (e.g., a fifth guided response generated by the actor model 210 at round t−1), and a guided Feedback ť′−1 (e.g., a third guided feedback) to the guided Response ť′−1 generated by the critic model 220 in the first round t−1 and the third guidance information. The third guidance information may be configured to guide the actor model 210 to generate the guided Response ť′ towards the second ground-truth response of the second sample question

Still in the round t, the actor model 210 may generate a guided Response t̅′ (e.g., an eighth guided response) based on second sample question, a guided Response [symbol] −1 (e.g., a seventh guided response generated by the actor model 210 at round t−1), a guided Feedback t̅−1 (e.g., a fourth guided feedback) to the guided Response [symbol] −1 generated by the critic model 220 in the first round t−1, and fourth guidance information. The fourth guidance information may be configured to guide the actor model 210 to generate the guided Response t̅′ to be distinguished from the second ground-truth response of the second sample question.

The critic model 220 may then be trained based on the predicted Response t′, the guided Response [symbol] , the guided Response t̅′, and the first ground-truth response of the second sample question.

In some example embodiments, a third reward difference between the reward of the predicted Response t′ and the reward of guided Response ť′ may be determined, and a fourth reward difference between the reward of the predicted Response t′ and the reward of guided Response [symbol] may be determined. Then, the actor model 210 may be trained based on the first reward difference and the second reward difference.

In some example embodiments, the third reward difference may be compared with a second threshold. In accordance with a determination that the third reward difference exceeds the second threshold, the guided Response [symbol] and the predicted Response t′ may be determined to be a third pair of positive and negative samples. Similarly, the fourth reward difference may be compared with the second threshold. In accordance with a determination that the fourth reward difference exceeds the second threshold, the predicted Response t′ and the guided Response [symbol] may be determined to be a fourth pair of positive and negative samples.

In an embodiment, a second DPO loss may be determined based on at least one of the third pair of positive and negative samples, and the fourth pair of positive and negative samples, and the actor model 210 may be trained based on the first DPO loss.

In an example embodiment of the present disclosure, for the question x with the answer y, let z^{(t-1)}=(zₐ^{(t-1)}, z_{c}^{(t-1)}) be the response of the actor model 210 and the feedback of the critic model 220 generated at round t−1. Let (zₐ^{(t)}, z_{c}^{(t)}) be the natural response (i.e., without guidance information) of the actor model 210 and the natural feedback (i.e., without guidance information) of the critic model 220. Let (z_{y,a}^{(t)},z_{y,c}^{(t)}) be the guided response of the actor model 210 and the guided feedback of the critic model 220 generated at the round t when guided with the positive guidance information. Let (z_{!y,a}^{(t)},z_{!y,c}^{(t)}) be the guided response of the actor model 210 and the guided feedback of the critic model 220 generated at the round t when guided with the negative guidance information.

Here, z_{c}^{(t)} may be an example of the Feedback t or t′ of the critic model 220 generated at the round t as described above, z_{y,c}^{(t)} may be an example of the guided Feedback ť or ť′ of the critic model 220 generated at the round t as described above, and z_{!y,c}^{(t)} may be an example of guided Feedback t̅ or t̅′ of the critic model 220 generated at the round t as described above. zₐ^{(t)} may be an example of the predicted Response t or t′ of the actor model 210 generated at the round t as described above, z_{y,c}^{(t)} may be an example of the guided Response ť or ť′ of the actor model 210 generated at the round t as described above, and z_{!y,c}^{(t)} may be an example of guided Response t̅ or t̅′ of the actor model 210 generated at the round t as described above.

To cause the guided responses to be different enough from predicted responses such that learning the guided responses results in consequential changes to the model, but not so different that they are challenging to learn. In some example embodiments, prompt modification is utilized.

To guide the generations of (z_{y,a}^{(t)},z_{y,c}^{(t)}) and (z_{!y,a}^{(t)},z_{!y,c}^{(t)}), a correct and wrong target answer are provided in the prompt respectively. For each guided response, it is considered how influential this response was in altering the accuracy of the final response, i.e., in the case of the actor, it is defined:

$${Δ}_{y} = r ( {z}_{y , a}^{( t )} , x , y ) - r ( {z}_{a}^{( t )} , x , y ) and {Δ}_{! y} = r ( {z}_{a}^{( t )} , x , y ) - r ( {z}_{! y , a}^{( t )} , x , y )$$

Here, r(zₐ^{(t)},x,y) may be an example of the reward of the predicted Response t or t′ of the actor model 210, r(z_{y,a}^{(t)},x,y) may be an example of the reward of the guided Response ť or ť′ of the actor model 210, r(z_{!y,a}^{(t)},x,y) may be an example of the reward of the predicted Response guided Response t̅ or t̅′ of the actor model 210.

The terms Δ_{y} and Δ_{!y} indicate the expected accuracy difference if at round t the actor model had given response z_{y,a}^{(t)} (or z_{!y,a}^{(t)}) instead of response zₐ^{(t)}. Large Δ_{y} indicates that a one-response difference during the debate was sufficient to push the procedure toward the correct answer. Such responses would be desirable for the model to learn. On the other hand, large values of Δ_{!y} indicate that a one-response difference easily causes the models to converge to the incorrect answer. This indicates that the debate procedure is particularly fragile at timestep t. With the Δ_{y} and Δ_{!y}, for a threshold ε, it is defined:

$$( {z}_{+}^{( t )} , {z}_{-}^{( t )} ) = \{ \begin{matrix}( {z}_{y}^{( t )} , {z}^{( t )} ) & if ε \leq {Δ}_{y} = r ( {z}_{y , a}^{( t )} , x , y ) - r ( {z}_{a}^{( t )} , x , y ) \\ ( {z}^{( t )} , {z}_{! y}^{( t )} ) & if ε \leq {Δ}_{! y} = r ( {z}_{a}^{( t )} , x , y ) - r ( {z}_{! y , a}^{( t )} , x , y )\end{matrix} \qquad ( 4 )$$

Here, the threshold & may be an example of the first or second threshold. r(z_{y,a}^{(t)},x,y)−r(zₐ^{(t)},x,y) may be an example of the first reward difference or the third reward difference. r(zₐ^{(t)},x,y)−r(z_{!y,a}^{(t)},x,y) may be an example of the second reward difference or the fourth reward difference. (z₊^{(t)}, z₋^{(t)}) may be an example of the first pair of positive and negative samples, the second pair of positive and negative samples, the third pair of positive and negative samples, or the fourth pair of positive and negative samples, depending on the relationship between the threshold ε and the reward difference (e.g., the first reward difference, the second reward difference, the third reward difference, or the fourth reward difference).

If neither value is above the threshold, then the example is thrown out. It should be noted that under Eq. (4), a positive example z₊^{(t)} may be interpreted as a guided response z_{y}^{(t)}, which increased the probability of debate converging to the correct answer by at least ε, when compared with the natural response z^{(t)}. Similarly, a negative example z₋^{(t)} may be interpreted as a guided response z_{y!}^{(t)}, which decreased the probability of debate converging to the answer by at least ε. Then, high-quality training examples consisting of positive and negative pairs may be generated.

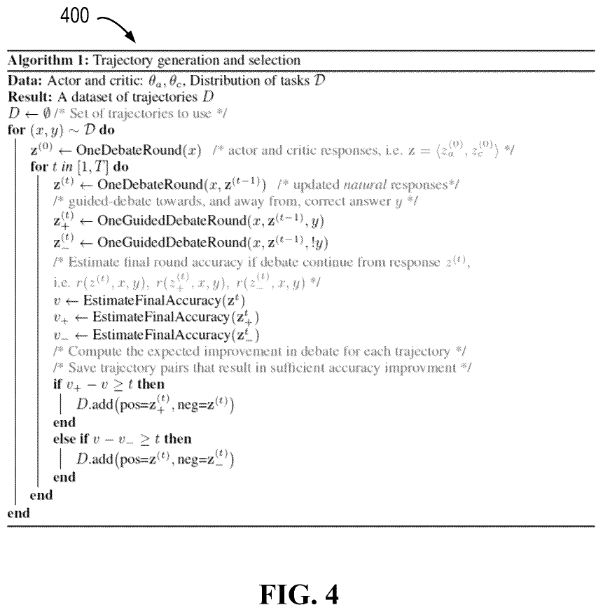

In an example embodiment, a DPO loss is used. Given a preference dataset of positive and negative examples for both the actor and critic model, of the from z₊^{(t)} and z₋^{(t)}, the DPO loss is defined as:

$${ℒ}_{DPO} = {\sum }_{t = 0}^{T} {𝔼}_{x , y , {z}_{-}^{( t )} , {z}_{+}^{( t )} ) ∼ D} [ log σ ( \frac{{π}_{θ} ( {z}_{+}^{( t )} \vert x , {z}^{( t - 1 )} )}{{π}_{ref} ( {z}_{+}^{( t )} \vert x , {z}^{( t - 1 )} )} - \frac{{π}_{θ} ( {z}_{-}^{( f )} \vert x , {z}^{( t - 1 )} )}{{π}_{ref} ( {z}_{-}^{( f )} \vert x , {z}^{( t - 1 )} )} ) ]$$

Where π_{θ} is the policy induced by parameters θₐ and θ_{c} are the model's responses at the previous round (i.e., the responses prior to giving either response z₊^{(t)} or z₋^{(t)}). By summing across all rounds, the probability that each round t yields a response z^{t} which causes debate to converge to the correct answer at time T may be maximized. The above whole framework is described in Algorithm 400 as illustrated in FIG. 4, and details are not repeated again.

According to embodiments of the present disclosure, a solution for jointly training a two-model team (one actor model and one critic model) to collaboratively solve problems through iterative discussion is provided. To train the actor model and the critic model, a guided-debate scheme for producing high-quality preference data for collaborative models is further provided. With the scheme, even a single round of training for both the actor model and critic model may result in a high-quality debate team. Furthermore, without ACC-Debate, the critic model may often too agreeable and lack verbosity in its feedback. In contrast, after training with ACC-Debate, the critic model may be more likely to provide detailed disagreements during debate.

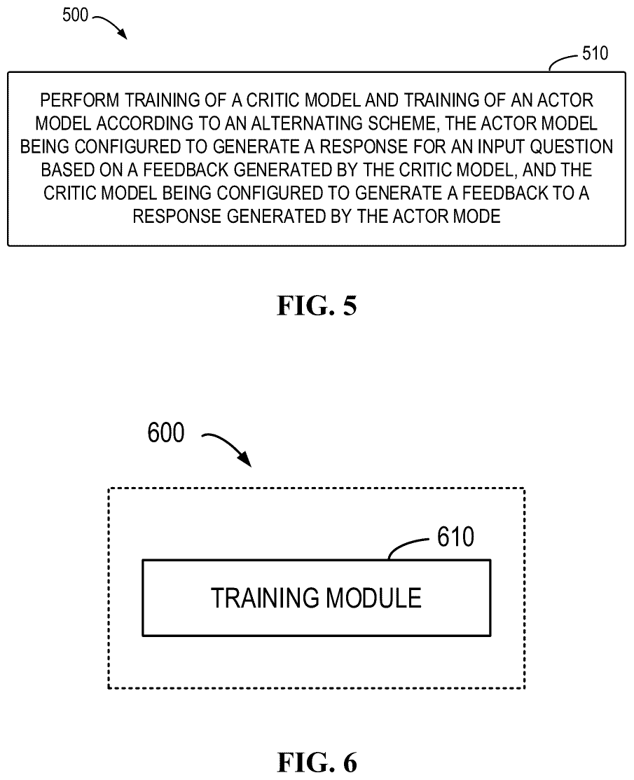

FIG. 5 illustrates a flowchart of a process 500 for model training in accordance with some embodiments of the present disclosure. The process 500 may be implemented at the model training system 110 of FIG. 1.

At block 510, the model training system 110 performs training of a critic model and training of an actor model according to an alternating scheme. The actor model is configured to generate a response for an input question based on a feedback generated by the critic model, and the critic model is configured to generate a feedback to a response generated by the actor mode. The training of the critic model includes training the critic model based on a first difference between a first target predicted response generated by the actor model for a first sample question and a first ground-truth response of the first sample question. The training of the actor model includes training the actor model based on a second difference between a second target predicted response generated by the actor model for a second sample question and a second ground-truth response of the second sample question

In some embodiments, training the critic model includes: generating, with the critic model and in a target round of interaction between the critic model and the actor model, a first predicted feedback to a first predicted response for the first sample question, the first predicted response being generated by the actor model at a previous round of iteration; generating, with the actor model, the first target predicted response for the first sample question in the target round based on the first sample question, the first predicted response, and the first predicted feedback; and training the critic model based on the first difference between the first target predicted response and the first ground-truth response of the first sample question.

In some embodiments, training the actor model includes: generating, with the critic model and in a target round of iteration between the critic model and the actor model, a second predicted feedback to a second predicted response for the second sample question, the second predicted response being generated by the actor model at a previous round of iteration; generating, with the actor model, the second target predicted response for the second sample question in the target round based on the second sample question, the second predicted response, and the second predicted feedback; and training the actor model based on the second difference between the second target predicted response and the second ground-truth response of the second sample question.

In some embodiments, training the critic model includes: generating, with the actor model, a second predicted response for the first sample question in a first round of iteration based on the first sample question, a first predicted response generated by the actor model at a previous round of iteration, and a first feedback to the first predicted response generated by the critic model in the first round; generating, with the actor model, a second guided response for the first sample question in the first round of iteration based on the first sample question, a first guided response, and a first guided feedback to the first guided response generated by the critic model in the first round, the first guided response being generated by the actor model at the previous round of iteration based on first guidance information, the first guidance information being configured to guide the actor model to generate the second guided response towards the first ground-truth response of the first sample question; generating, with the actor model, a fourth guided response for the first sample question in the first round of iteration based on the first sample question, a third guided response, and a second guided feedback to the third guided response generated by the critic model in the first round, the third guided response being generated by the actor model at the previous round of iteration based on second guidance information, the second guidance information being configured to guide the actor model to generate the fourth guided response to be distinguished from the first ground-truth response of the first sample question; training the critic model based on the second predicted response, the second guided response, the fourth guided response, and the first ground-truth response of the first sample question. The first target predicted response being generated based on the second predicted response.

In some embodiments, training the critic model includes: determining a first reward difference between a reward of the second predicted response and a reward of the second guided response based on the first ground-truth response of the first sample question; determining a second reward difference between the reward of the second predicted response and a reward of the fourth guided response based on the first ground-truth response of the first sample question; and training the critic model based on the first reward difference and the second reward difference.

In some embodiments, training the critic model based on the first reward difference and the second reward difference includes: in accordance with a determination that the first reward difference exceeds a first threshold, determine the second guided response and the second predicted response to be a first pair of positive and negative samples; in accordance with a determination that the second reward difference exceeds the first threshold, determine the second predicted response and the fourth guided response to be a second pair of positive and negative samples; determining a first direct preference optimization (DPO) loss based on at least one of the first pair of positive and negative samples, and the second pair of positive and negative samples; and training the critic model based on the first DPO loss.

In some embodiments, training the actor model includes: generating, with the actor model, a fourth predicted response for the second sample question in a first round of iteration based on the second sample question, a third predicted response generated by the actor model at a previous round of iteration, and a second feedback to the third predicted response generated by the critic model in the first round; generating, with the actor model, an sixth guided response for the second sample question in the first round of iteration based on the second sample question, a fifth guided response, and a third guided feedback to the fifth guided response generated by the critic model in the first round, the fifth guided response being generated by the actor model at the previous round of iteration based on third guidance information, the third guidance information being configured to guide the actor model to generate the sixth guided response towards the second ground-truth response of the second sample question; generating, with the actor model, an eighth guided response for the second sample question in the first round of iteration based on the second sample question, a seventh guided response, and a fourth guided feedback to the seventh guided response generated by the critic model in the first round, the seventh guided response being generated by the actor model at the previous round of iteration based on fourth guidance information, the fourth guidance information being configured to guide the actor model to generate the eighth guided response to be distinguished from the second ground-truth response of the second sample question; training the actor model based on the fourth predicted response, the sixth guided response, the eighth guided response, and the second ground-truth response of the second sample question. The second target predicted response being generated based on the fourth predicted response.

In some embodiments, training the actor model includes: determining a third reward difference between a reward of the fourth predicted response and a reward of the sixth guided response based on the second ground-truth response of the second sample question; determining a fourth reward difference between the reward of the fourth predicted response and a reward of the eighth guided response based on the second ground-truth response of the second sample question; and training the actor model based on the third reward difference and the fourth reward difference.

In some embodiments, training the actor model based on the third reward difference and the fourth reward difference includes: in accordance with a determination that the third reward difference exceeds a second threshold, determine the sixth guided response and the fourth predicted response to be a third pair of positive and negative samples; in accordance with a determination that the fourth reward difference exceeds the second threshold, determine the fourth predicted response and the eighth guided response to be a fourth pair of positive and negative samples; determining a second DPO loss based on at least one of the third pair of positive and negative samples, and the fourth pair of positive and negative samples; and training the actor model based on the second DPO loss.

FIG. 6 illustrates a block diagram of an apparatus 600 for model training according to some embodiments of the present disclosure.

As illustrated in FIG. 6, the apparatus 600 includes a training module 610 configured to perform training of a critic model and training of an actor model according to an alternating scheme. The actor model is configured to generate a response for an input question based on a feedback generated by the critic model, and the critic model is configured to generate a feedback to a response generated by the actor mode. The training module includes a first training submodule configured to train the critic model based on a first difference between a first target predicted response generated by the actor model for a first sample question and a first ground-truth response of the first sample question. The training module includes a second training submodule configured to train the actor model based on a second difference between a second target predicted response generated by the actor model for a second sample question and a second ground-truth response of the second sample question.

In some embodiments, the first training submodule is further configured to: generate, with the critic model and in a target round of interaction between the critic model and the actor model, a first predicted feedback to a first predicted response for the first sample question, the first predicted response being generated by the actor model at a previous round of iteration; generate, with the actor model, the first target predicted response for the first sample question in the target round based on the first sample question, the first predicted response, and the first predicted feedback; and train the critic model based on the first difference between the first target predicted response and the first ground-truth response of the first sample question.

In some embodiments, the second training submodule is further configured to: generate, with the critic model and in a target round of iteration between the critic model and the actor model, a second predicted feedback to a second predicted response for the second sample question, the second predicted response being generated by the actor model at a previous round of iteration; generate, with the actor model, the second target predicted response for the second sample question in the target round based on the second sample question, the second predicted response, and the second predicted feedback; and train the actor model based on the second difference between the second target predicted response and the second ground-truth response of the second sample question.

In some embodiments, the first training submodule is further configured to: generate, with the actor model, a second predicted response for the first sample question in a first round of iteration based on the first sample question, a first predicted response generated by the actor model at a previous round of iteration, and a first feedback to the first predicted response generated by the critic model in the first round; generate, with the actor model, a second guided response for the first sample question in the first round of iteration based on the first sample question, a first guided response, and a first guided feedback to the first guided response generated by the critic model in the first round, the first guided response being generated by the actor model at the previous round of iteration based on first guidance information, the first guidance information being configured to guide the actor model to generate the second guided response towards the first ground-truth response of the first sample question; generate, with the actor model, a fourth guided response for the first sample question in the first round of iteration based on the first sample question, a third guided response, and a second guided feedback to the third guided response generated by the critic model in the first round, the third guided response being generated by the actor model at the previous round of iteration based on second guidance information, the second guidance information being configured to guide the actor model to generate the fourth guided response to be distinguished from the first ground-truth response of the first sample question; train the critic model based on the second predicted response, the second guided response, the fourth guided response, and the first ground-truth response of the first sample question. The first target predicted response being generated based on the second predicted response.

In some embodiments, the first training submodule is further configured to: determine a first reward difference between a reward of the second predicted response and a reward of the second guided response based on the first ground-truth response of the first sample question; determine a second reward difference between the reward of the second predicted response and a reward of the fourth guided response based on the first ground-truth response of the first sample question; and train the critic model based on the first reward difference and the second reward difference.

In some embodiments, the first training submodule is further configured to: in accordance with a determination that the first reward difference exceeds a first threshold, determine the second guided response and the second predicted response to be a first pair of positive and negative samples; in accordance with a determination that the second reward difference exceeds the first threshold, determine the second predicted response and the fourth guided response to be a second pair of positive and negative samples; determine a first direct preference optimization (DPO) loss based on at least one of the first pair of positive and negative samples, and the second pair of positive and negative samples; and train the critic model based on the first DPO loss.

In some embodiments, the second training submodule is further configured to: generate, with the actor model, a fourth predicted response for the second sample question in a first round of iteration based on the second sample question, a third predicted response generated by the actor model at a previous round of iteration, and a second feedback to the third predicted response generated by the critic model in the first round; generate, with the actor model, an sixth guided response for the second sample question in the first round of iteration based on the second sample question, a fifth guided response, and a third guided feedback to the fifth guided response generated by the critic model in the first round, the fifth guided response being generated by the actor model at the previous round of iteration based on third guidance information, the third guidance information being configured to guide the actor model to generate the sixth guided response towards the second ground-truth response of the second sample question; generate, with the actor model, an eighth guided response for the second sample question in the first round of iteration based on the second sample question, a seventh guided response, and a fourth guided feedback to the seventh guided response generated by the critic model in the first round, the seventh guided response being generated by the actor model at the previous round of iteration based on fourth guidance information, the fourth guidance information being configured to guide the actor model to generate the eighth guided response to be distinguished from the second ground-truth response of the second sample question; train the actor model based on the fourth predicted response, the sixth guided response, the eighth guided response, and the second ground-truth response of the second sample question. The second target predicted response being generated based on the fourth predicted response.

In some embodiments, the second training submodule is further configured to: determine a third reward difference between a reward of the fourth predicted response and a reward of the sixth guided response based on the second ground-truth response of the second sample question; determine a fourth reward difference between the reward of the fourth predicted response and a reward of the eighth guided response based on the second ground-truth response of the second sample question; and train the actor model based on the third reward difference and the fourth reward difference.

In some embodiments, the second training submodule is further configured to: in accordance with a determination that the third reward difference exceeds a second threshold, determine the sixth guided response and the fourth predicted response to be a third pair of positive and negative samples; in accordance with a determination that the fourth reward difference exceeds the second threshold, determine the fourth predicted response and the eighth guided response to be a fourth pair of positive and negative samples; determine a second DPO loss based on at least one of the third pair of positive and negative samples, and the fourth pair of positive and negative samples; and train the actor model based on the second DPO loss.

In embodiments of the present disclosure, an electronic device is provided. The device includes at least one processing unit; and at least one memory coupled to the at least one processing unit and storing instructions executable by the at least one processing unit. The instructions, upon execution by the at least one processing unit, cause the device to perform the method of the first aspect.

In embodiments of the present disclosure, a computer-readable storage medium is provided. The medium stores a computer program which, when executed by a processor, causes the method of the first aspect to be implemented.

In embodiments of the present disclosure, a computer program product is provided. The computer program product includes a computer program which, when executed by a processor, causes the method of the first aspect to be implemented.

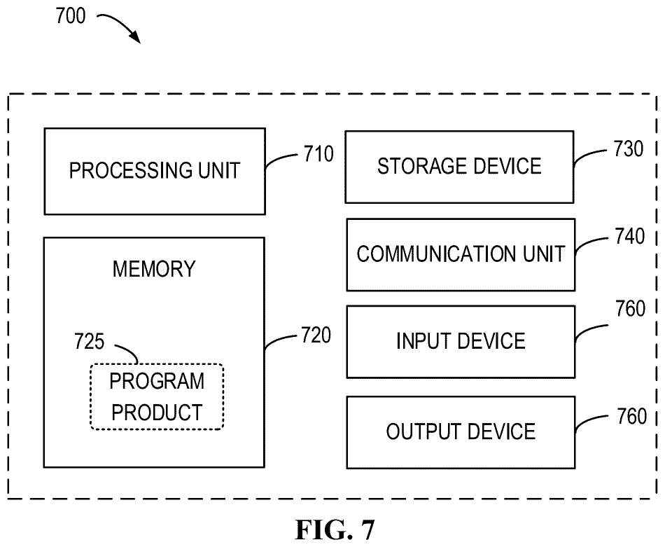

FIG. 7 illustrates a block diagram of an electronic device 600 in which one or more embodiments of the present disclosure can be implemented. It would be appreciated that the electronic device 700 shown in FIG. 7 is only an example and should not constitute any restriction on the function and scope of the embodiments described herein. The electronic device 700 may be used, for example, to implement the model training system 110 of FIG. 1. The electronic device 700 may also be used to implement the apparatus 600 of FIG. 6.

As shown in FIG. 7, the electronic device 700 is in the form of a general computing device. The components of the electronic device 700 may include, but are not limited to, one or more processors or processing units 710, a memory 720, a storage device 730, one or more communication units 740, one or more input devices 760, and one or more output devices 760. The processing unit 710 may be an actual or virtual processor and can execute various processes according to the programs stored in the memory 720. In a multiprocessor system, multiple processing units execute computer executable instructions in parallel to improve the parallel processing capability of the electronic device 700.

The electronic device 700 typically includes a variety of computer storage medium. Such medium may be any available medium that is accessible to the electronic device 700, including but not limited to volatile and non-volatile medium, removable and non-removable medium. The memory 720 may be volatile memory (for example, a register, cache, a random access memory (RAM)), a non-volatile memory (for example, a read-only memory (ROM), an electrically erasable programmable read-only memory (EEPROM), a flash memory) or any combination thereof. The storage device 730 may be any removable or non-removable medium, and may include a machine-readable medium, such as a flash drive, a disk, or any other medium, which can be used to store information and/or data (such as training data for training) and can be accessed within the electronic device 700.

The electronic device 700 may further include additional removable/non-removable, volatile/non-volatile storage medium. Although not shown in FIG. 7, a disk driver for reading from or writing to a removable, non-volatile disk (such as a “floppy disk”), and an optical disk driver for reading from or writing to a removable, non-volatile optical disk can be provided. In these cases, each driver may be connected to the bus (not shown) by one or more data medium interfaces. The memory 720 may include a computer program product 725, which has one or more program modules configured to perform various methods or acts of various embodiments of the present disclosure.

The communication unit 740 communicates with a further computing device through the communication medium. In addition, functions of components in the electronic device 700 may be implemented by a single computing cluster or multiple computing machines, which can communicate through a communication connection. Therefore, the electronic device 700 may be operated in a networking environment using a logical connection with one or more other servers, a network personal computer (PC), or another network node.

The input device 760 may be one or more input devices, such as a mouse, a keyboard, a trackball, etc. The output device 760 may be one or more output devices, such as a display, a speaker, a printer, etc. The electronic device 700 may also communicate with one or more external devices (not shown) through the communication unit 740 as required. The external device, such as a storage device, a display device, etc., communicate with one or more devices that enable users to interact with the electronic device 700, or communicate with any device (for example, a network card, a modem, etc.) that makes the electronic device 700 communicate with one or more other computing devices. Such communication may be executed via an input/output (I/O) interface (not shown).

According to example implementation of the present disclosure, a computer-readable storage medium is provided, on which a computer-executable instruction or computer program is stored, where the computer-executable instructions or the computer program is executed by the processor to implement the method described above. According to example implementation of the present disclosure, a computer program product is also provided. The computer program product is physically stored on a non-transient computer-readable medium and includes computer-executable instructions, which are executed by the processor to implement the method described above.

Various aspects of the present disclosure are described herein with reference to the flow chart and/or the block diagram of the method, the device, the equipment and the computer program product implemented in accordance with the present disclosure. It would be appreciated that each block of the flowchart and/or the block diagram and the combination of each block in the flowchart and/or the block diagram may be implemented by computer-readable program instructions.

These computer-readable program instructions may be provided to the processing units of general-purpose computers, special computers or other programmable data processing devices to produce a machine that generates a device to implement the functions/acts specified in one or more blocks in the flow chart and/or the block diagram when these instructions are executed through the processing units of the computer or other programmable data processing devices. These computer-readable program instructions may also be stored in a computer-readable storage medium. These instructions enable a computer, a programmable data processing device and/or other devices to work in a specific way. Therefore, the computer-readable medium containing the instructions includes a product, which includes instructions to implement various aspects of the functions/acts specified in one or more blocks in the flowchart and/or the block diagram.

The computer-readable program instructions may be loaded onto a computer, other programmable data processing apparatus, or other devices, so that a series of operational steps can be performed on a computer, other programmable data processing apparatus, or other devices, to generate a computer-implemented process, such that the instructions which execute on a computer, other programmable data processing apparatus, or other devices implement the functions/acts specified in one or more blocks in the flowchart and/or the block diagram.

The flowchart and the block diagram in the drawings show the possible architecture, functions and operations of the system, the method and the computer program product implemented in accordance with the present disclosure. In this regard, each block in the flowchart or the block diagram may represent a part of a module, a program segment or instructions, which contains one or more executable instructions for implementing the specified logic function. In some alternative implementations, the functions marked in the block may also occur in a different order from those marked in the drawings. For example, two consecutive blocks may actually be executed in parallel, and sometimes can also be executed in a reverse order, depending on the function involved. It should also be noted that each block in the block diagram and/or the flowchart, and combinations of blocks in the block diagram and/or the flowchart, may be implemented by a dedicated hardware-based system that performs the specified functions or acts, or by the combination of dedicated hardware and computer instructions.

Each implementation of the present disclosure has been described above. The above description is example, not exhaustive, and is not limited to the disclosed implementations. Without departing from the scope and spirit of the described implementations, many modifications and changes are obvious to ordinary skill in the art. The selection of terms used in this article aims to best explain the principles, practical application or improvement of technology in the market of each implementation, or to enable other ordinary skill in the art to understand the various embodiments disclosed herein.

What is claimed is:

1. A method for model training, comprising:
performing training of a critic model and training of an actor model according to an alternating scheme, the actor model being configured to generate a response for an input question based on a feedback generated by the critic model, and the critic model being configured to generate a feedback to a response generated by the actor mode; and
wherein the training of the critic model comprises:
training the critic model based on a first difference between a first target predicted response generated by the actor model for a first sample question and a first ground-truth response of the first sample question;
wherein the training of the actor model comprises:
training the actor model based on a second difference between a second target predicted response generated by the actor model for a second sample question and a second ground-truth response of the second sample question.

2. The method of claim 1, wherein training the critic model comprises:
generating, with the critic model and in a target round of interaction between the critic model and the actor model, a first predicted feedback to a first predicted response for the first sample question, the first predicted response being generated by the actor model at a previous round of iteration;
generating, with the actor model, the first target predicted response for the first sample question in the target round based on the first sample question, the first predicted response, and the first predicted feedback; and
training the critic model based on the first difference between the first target predicted response and the first ground-truth response of the first sample question.

3. The method of claim 1, wherein training the actor model comprises:
generating, with the critic model and in a target round of iteration between the critic model and the actor model, a second predicted feedback to a second predicted response for the second sample question, the second predicted response being generated by the actor model at a previous round of iteration;
generating, with the actor model, the second target predicted response for the second sample question in the target round based on the second sample question, the second predicted response, and the second predicted feedback; and
training the actor model based on the second difference between the second target predicted response and the second ground-truth response of the second sample question.

4. The method of claim 1, wherein training the critic model comprises:
generating, with the actor model, a second predicted response for the first sample question in a first round of iteration based on the first sample question, a first predicted response generated by the actor model at a previous round of iteration, and a first feedback to the first predicted response generated by the critic model in the first round;
generating, with the actor model, a second guided response for the first sample question in the first round of iteration based on the first sample question, a first guided response, and a first guided feedback to the first guided response generated by the critic model in the first round, the first guided response being generated by the actor model at the previous round of iteration based on first guidance information, the first guidance information being configured to guide the actor model to generate the second guided response towards the first ground-truth response of the first sample question;
generating, with the actor model, a fourth guided response for the first sample question in the first round of iteration based on the first sample question, a third guided response, and a second guided feedback to the third guided response generated by the critic model in the first round, the third guided response being generated by the actor model at the previous round of iteration based on second guidance information, the second guidance information being configured to guide the actor model to generate the fourth guided response to be distinguished from the first ground-truth response of the first sample question;
training the critic model based on the second predicted response, the second guided response, the fourth guided response, and the first ground-truth response of the first sample question; wherein the first target predicted response being generated based on the second predicted response.

5. The method of claim 4, wherein training the critic model comprises:
determining a first reward difference between a reward of the second predicted response and a reward of the second guided response based on the first ground-truth response of the first sample question;
determining a second reward difference between the reward of the second predicted response and a reward of the fourth guided response based on the first ground-truth response of the first sample question; and
training the critic model based on the first reward difference and the second reward difference.

6. The method of claim 5, wherein training the critic model based on the first reward difference and the second reward difference comprises:
in accordance with a determination that the first reward difference exceeds a first threshold, determine the second guided response and the second predicted response to be a first pair of positive and negative samples;
in accordance with a determination that the second reward difference exceeds the first threshold, determine the second predicted response and the fourth guided response to be a second pair of positive and negative samples;
determining a first direct preference optimization (DPO) loss based on at least one of the first pair of positive and negative samples, and the second pair of positive and negative samples; and
training the critic model based on the first DPO loss.

7. The method of claim 1, wherein training the actor model comprises:
generating, with the actor model, a fourth predicted response for the second sample question in a first round of iteration based on the second sample question, a third predicted response generated by the actor model at a previous round of iteration, and a second feedback to the third predicted response generated by the critic model in the first round;
generating, with the actor model, an sixth guided response for the second sample question in the first round of iteration based on the second sample question, a fifth guided response, and a third guided feedback to the fifth guided response generated by the critic model in the first round, the fifth guided response being generated by the actor model at the previous round of iteration based on third guidance information, the third guidance information being configured to guide the actor model to generate the sixth guided response towards the second ground-truth response of the second sample question;
generating, with the actor model, an eighth guided response for the second sample question in the first round of iteration based on the second sample question, a seventh guided response, and a fourth guided feedback to the seventh guided response generated by the critic model in the first round, the seventh guided response being generated by the actor model at the previous round of iteration based on fourth guidance information, the fourth guidance information being configured to guide the actor model to generate the eighth guided response to be distinguished from the second ground-truth response of the second sample question;
training the actor model based on the fourth predicted response, the sixth guided response, the eighth guided response, and the second ground-truth response of the second sample question; wherein the second target predicted response being generated based on the fourth predicted response.

8. The method of claim 7, wherein training the actor model comprises:
determining a third reward difference between a reward of the fourth predicted response and a reward of the sixth guided response based on the second ground-truth response of the second sample question;
determining a fourth reward difference between the reward of the fourth predicted response and a reward of the eighth guided response based on the second ground-truth response of the second sample question; and
training the actor model based on the third reward difference and the fourth reward difference.

9. The method of claim 8, wherein training the actor model based on the third reward difference and the fourth reward difference comprises:
in accordance with a determination that the third reward difference exceeds a second threshold, determine the sixth guided response and the fourth predicted response to be a third pair of positive and negative samples;
in accordance with a determination that the fourth reward difference exceeds the second threshold, determine the fourth predicted response and the eighth guided response to be a fourth pair of positive and negative samples;
determining a second DPO loss based on at least one of the third pair of positive and negative samples, and the fourth pair of positive and negative samples; and
training the actor model based on the second DPO loss.

10. An electronic device, comprising:
at least one processor; and
at least one memory communicatively coupled to the at least one processor and comprising computer-readable instructions that upon execution by the at least one processor cause the at least one processor to perform acts comprising:
performing training of a critic model and training of an actor model according to an alternating scheme, the actor model being configured to generate a response for an input question based on a feedback generated by the critic model, and the critic model being configured to generate a feedback to a response generated by the actor mode; and
wherein the training of the critic model comprises:
training the critic model based on a first difference between a first target predicted response generated by the actor model for a first sample question and a first ground-truth response of the first sample question;
wherein the training of the actor model comprises:
training the actor model based on a second difference between a second target predicted response generated by the actor model for a second sample question and a second ground-truth response of the second sample question.

11. The method of claim 10, wherein training the critic model comprises:
generating, with the critic model and in a target round of interaction between the critic model and the actor model, a first predicted feedback to a first predicted response for the first sample question, the first predicted response being generated by the actor model at a previous round of iteration;
generating, with the actor model, the first target predicted response for the first sample question in the target round based on the first sample question, the first predicted response, and the first predicted feedback; and
training the critic model based on the first difference between the first target predicted response and the first ground-truth response of the first sample question.

12. The method of claim 10, wherein training the actor model comprises:
generating, with the critic model and in a target round of iteration between the critic model and the actor model, a second predicted feedback to a second predicted response for the second sample question, the second predicted response being generated by the actor model at a previous round of iteration;
generating, with the actor model, the second target predicted response for the second sample question in the target round based on the second sample question, the second predicted response, and the second predicted feedback; and
training the actor model based on the second difference between the second target predicted response and the second ground-truth response of the second sample question.

13. The method of claim 10, wherein training the critic model comprises:
generating, with the actor model, a second predicted response for the first sample question in a first round of iteration based on the first sample question, a first predicted response generated by the actor model at a previous round of iteration, and a first feedback to the first predicted response generated by the critic model in the first round;
generating, with the actor model, a second guided response for the first sample question in the first round of iteration based on the first sample question, a first guided response, and a first guided feedback to the first guided response generated by the critic model in the first round, the first guided response being generated by the actor model at the previous round of iteration based on first guidance information, the first guidance information being configured to guide the actor model to generate the second guided response towards the first ground-truth response of the first sample question;
generating, with the actor model, a fourth guided response for the first sample question in the first round of iteration based on the first sample question, a third guided response, and a second guided feedback to the third guided response generated by the critic model in the first round, the third guided response being generated by the actor model at the previous round of iteration based on second guidance information, the second guidance information being configured to guide the actor model to generate the fourth guided response to be distinguished from the first ground-truth response of the first sample question;
training the critic model based on the second predicted response, the second guided response, the fourth guided response, and the first ground-truth response of the first sample question; wherein the first target predicted response being generated based on the second predicted response.

14. The method of claim 13, wherein training the critic model comprises:
determining a first reward difference between a reward of the second predicted response and a reward of the second guided response based on the first ground-truth response of the first sample question;
determining a second reward difference between the reward of the second predicted response and a reward of the fourth guided response based on the first ground-truth response of the first sample question; and
training the critic model based on the first reward difference and the second reward difference.

15. The method of claim 14, wherein training the critic model based on the first reward difference and the second reward difference comprises:
in accordance with a determination that the first reward difference exceeds a first threshold, determine the second guided response and the second predicted response to be a first pair of positive and negative samples;
in accordance with a determination that the second reward difference exceeds the first threshold, determine the second predicted response and the fourth guided response to be a second pair of positive and negative samples;
determining a first direct preference optimization (DPO) loss based on at least one of the first pair of positive and negative samples, and the second pair of positive and negative samples; and
training the critic model based on the first DPO loss.

16. The method of claim 10, wherein training the actor model comprises:
generating, with the actor model, a fourth predicted response for the second sample question in a first round of iteration based on the second sample question, a third predicted response generated by the actor model at a previous round of iteration, and a second feedback to the third predicted response generated by the critic model in the first round;
generating, with the actor model, an sixth guided response for the second sample question in the first round of iteration based on the second sample question, a fifth guided response, and a third guided feedback to the fifth guided response generated by the critic model in the first round, the fifth guided response being generated by the actor model at the previous round of iteration based on third guidance information, the third guidance information being configured to guide the actor model to generate the sixth guided response towards the second ground-truth response of the second sample question;
generating, with the actor model, an eighth guided response for the second sample question in the first round of iteration based on the second sample question, a seventh guided response, and a fourth guided feedback to the seventh guided response generated by the critic model in the first round, the seventh guided response being generated by the actor model at the previous round of iteration based on fourth guidance information, the fourth guidance information being configured to guide the actor model to generate the eighth guided response to be distinguished from the second ground-truth response of the second sample question;
training the actor model based on the fourth predicted response, the sixth guided response, the eighth guided response, and the second ground-truth response of the second sample question; wherein the second target predicted response being generated based on the fourth predicted response.

17. The method of claim 16, wherein training of the actor model comprises:
determining a third reward difference between a reward of the fourth predicted response and a reward of the sixth guided response based on the second ground-truth response of the second sample question;
determining a fourth reward difference between the reward of the fourth predicted response and a reward of the eighth guided response based on the second ground-truth response of the second sample question; and
training the actor model based on the third reward difference and the fourth reward difference.

18. The method of claim 17, wherein training the actor model based on the third reward difference and the fourth reward difference comprises:
in accordance with a determination that the third reward difference exceeds a second threshold, determine the sixth guided response and the fourth predicted response to be a third pair of positive and negative samples;
in accordance with a determination that the fourth reward difference exceeds the second threshold, determine the fourth predicted response and the eighth guided response to be a fourth pair of positive and negative samples;
determining a second DPO loss based on at least one of the third pair of positive and negative samples, and the fourth pair of positive and negative samples; and
training the actor model based on the second DPO loss.

19. A non-transitory computer-readable storage medium, storing computer-readable instructions that upon execution by a computing device cause the computing device to perform acts comprising:
performing training of a critic model and training of an actor model according to an alternating scheme, the actor model being configured to generate a response for an input question based on a feedback generated by the critic model, and the critic model being configured to generate a feedback to a response generated by the actor mode; and
wherein the training of the critic model comprises:
training the critic model based on a first difference between a first target predicted response generated by the actor model for a first sample question and a first ground-truth response of the first sample question;
wherein the training of the actor model comprises:
training the actor model based on a second difference between a second target predicted response generated by the actor model for a second sample question and a second ground-truth response of the second sample question.
